(19) United States
(12) Patent Application Publication
(10) Pub. No.: US 2011/0219160 A1
(43) Pub. Date: Sep. 8, 2011

(54) FAST TWO WIRE INTERFACE AND PROTOCOL FOR TRANSFERRING DATA

(75) Inventors: Emil Lambrache, Campbell, CA (US); Benjamin F. Froemming, San Jose, CA (US)

(73) Assignee: ATMEL CORPORATION, SAN JOSE, CA (US)

(21) Appl. No.: 13/108,928

(22) Filed: May 16, 2011

Related U.S. Application Data
(63) Continuation of application No. 11/166,290, filed on Jun. 23, 2005, now abandoned.

(51) Int. Cl. G06F 13/14

(52) U.S. Cl. 710/305

(57) ABSTRACT

An apparatus and method for exchanging data between devices. An interface between at least two devices features a serial clock line coupled to each device and a bidirectional serial data line coupled to each device. A delay relative to the clock signal is added to an edge of an output enable signal to prevent a collision between devices when control of the data line is switched. Multiple masters and slaves may be connected to the interface.

### CROSS-REFERENCE TO RELATED APPLICATIONS

This application is a continuation of and claims priority to U.S. application Ser. No. 11/166,290, filed on Jun. 23, 2005, entitled “Fast Two Wire Interface and Protocol for Transferring Data,” the entire contents of which are incorporated by reference.

### TECHNICAL FIELD

This invention relates to transmitting data between two devices, especially transmitting data using a two-wire interface.

### BACKGROUND ART

A common serial communication interface, as shown in FIG. 1, includes a master device 10 connected to a slave device 16 by two lines: the serial clock (“SCL”) line 12 and the serial data (“SD”) line 14. These two lines or wires 12, 14 are used for data transfer. One or more slave devices 16 may be connected to a master device 10 by these lines 12, 14. Each slave device 16 has an address and responds to its own address.

With reference to FIG. 2, the bus interface of FIG. 1 may be implemented as an open drain 20, 26 driven bus with a pull-up resistor 22. Each device has a unique address. The pull-up resistor 22 is connected to a positive supply voltage. Two inverters 18, 28 are also present. The shared wire avoids collision between the active pull-up and pull-down transistors 20, 26. The speed of the bus 30 is limited by bus load capacitance C_{load} 24 (the total capacitance of the wire, connections, and pins). The rise time τ of the line is measured as R_{pull up}*C_{load}. When a fast rise time is desired, a small resistance value is chosen for the pull-up resistor 22, resulting in a high current in the pull-down transistors 20, 26 when they drive the SD line 14 low. However, if the current is too high, the chip will heat up and the chip may be damaged; this is especially problematic in small packages. The fastest speed at which this bus can operate is 200 KHz; 100 KHz is more common. Both speeds are relatively slow for many applications, including, but not limited to debugging applications, especially if data needs to be exchanged back and forth between devices. Therefore, it would be advantageous to provide a two-wire interface without this and other limitations.

### SUMMARY

In one embodiment, an interface between at least two devices features a serial clock line and a bidirectional serial data line, each of the lines coupled to each of the devices. A first driver associated with the first of the at least two devices is configured to drive data on the bi-directional serial data line when a first device enable signal is asserted. The first device enable signal has a first delay relative to a clock signal added to an edge of the first device enable signal. This delay is added to the edge of the first device enable signal to avoid a collision between the first device and the second of the at least two devices when switching control of the bi-directional serial data between the first and second devices.

In another embodiment, an interface between at least two devices has a serial clock line and a bi-directional serial data line coupled to each of the devices. Each device has means for adding a delay to an edge of a signal enabling the device to drive data on the bi-directional serial data line. The delay is relative to a clock signal from the serial clock line. The delay is added to avoid a collision between two devices when switching control of the bi-directional serial data line between two devices.

In yet another embodiment, a method for transmitting data between at least two devices over an interface features a first device driving data over a bi-directional serial data line coupled to each device. Data is driven in response to a first enabling signal. The first enabling signal has a first delay relative to a clock signal from a signal clock line added to an edge of the first enabling signal.

### DESCRIPTION OF DRAWINGS

FIG. 1 is a block diagram of a prior art two-wire interface.

FIG. 2 is a circuit diagram of a two-wire interface known in the prior art.

FIG. 3 is a circuit diagram of a two-wire interface in one embodiment of the invention.

FIG. 4 is a timing diagram of a two-wire interface in one embodiment of the invention.

FIG. 5 is block diagram of a byte frame in one embodiment of the invention.

FIG. 6 is a timing diagram for the two-wire interface in one embodiment of the invention.

FIG. 7 is a block diagram of a delay circuit employed in one embodiment of the invention.

FIG. 8 is a circuit diagram of the delay circuit of FIG. 7 employed in one embodiment of the invention.

FIG. 9 is a circuit diagram of the two-wire interface in one embodiment of the invention.

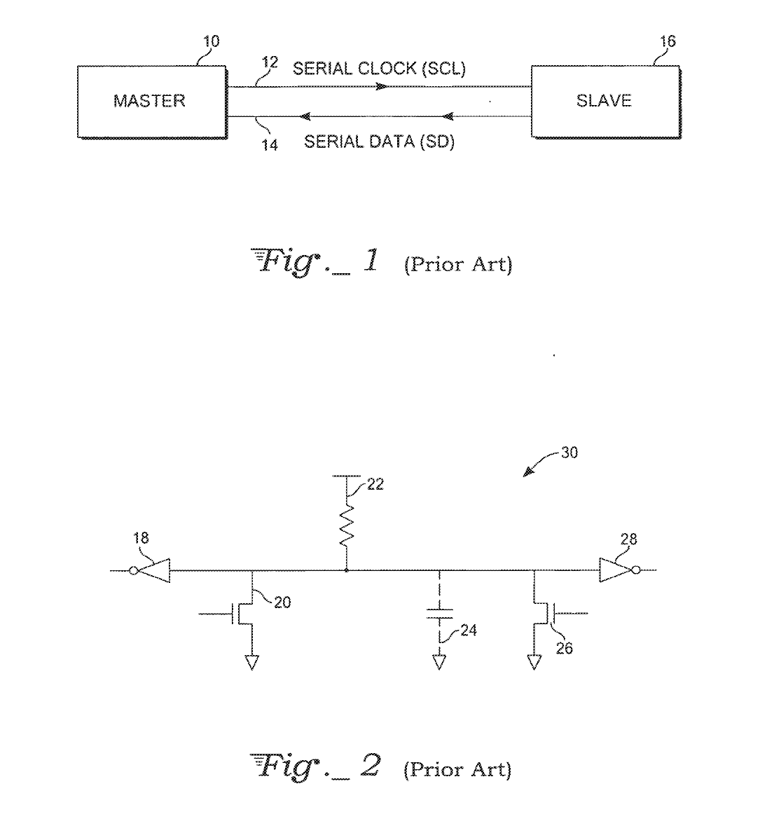

### DETAILED DESCRIPTION

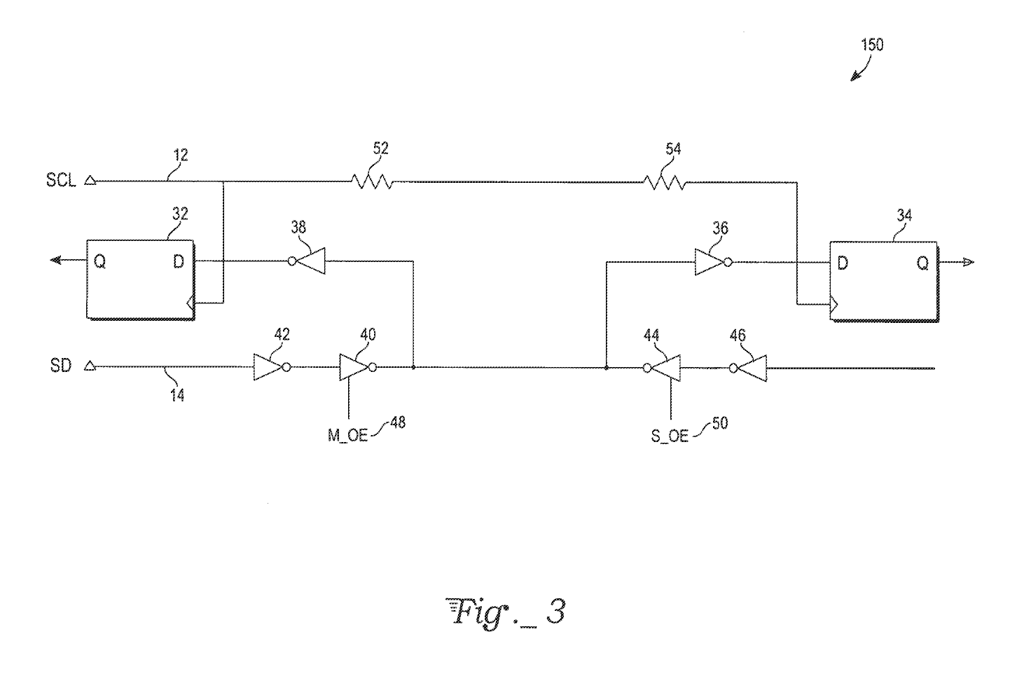

In FIG. 3, an exemplary embodiment of two-wire interface 150 is shown that does not employ a pull-up resistor. In this embodiment, a master and slave arrangement is described; however, in other embodiments the two connected devices do not have to be master and slave (for instance, the devices may be in peer-to-peer relationship or, in other embodiments, the designation of master and slave could depend on the direction of data transfer at any given time). Two pins on each device connect to the two bus lines: the serial clock line (“SCL”) 12 and the bidirectional serial data line (“SD”) 14. There is some resistance 52, 54 (in the line) over SCL 12 between the devices. Rather than employing pullup resistors, the interface 150 uses tri-state buffers 40, 44 as drivers. The control signals 48, 50 for each of the tri-state buffers 40, 44 are the master output enable (“M_OE”) 48 and slave output enable (“S_OE”) 50 signals (when an output enable signal is HIGH, the corresponding device has the line). Each device also has an inverter 42, 46 to invert data being driven on the SD line 14. For incoming data, each device has an inverter 38, 36; each device also has an edge-triggered flip-flop 32, 34 which provides a delay when sampling incoming data, as will be discussed in greater detail below. When only two devices are connected to the interface, no addressing is required.

To avoid a collision when switching control of the SD line between devices, a delay is embedded in the interface protocol. In addition to the several nanoseconds it takes the tri-state buffers to deassert control of the line, the output enable signals (corresponding to the device that will surrender the line and the device that will control the line) have delays added to them (the mechanism by which this is done is discussed below) so that one device does not try to take control of the line while it is under the control of another device.

Switching control of the line should not generate a STOP condition. For instance, in one embodiment, a HIGH to LOW transition on the SD line while SCL is HIGH indicates a START condition while a LOW to HIGH transition on the SD line while SCL is HIGH indicates a STOP condition. Therefore, in this embodiment, control of the SD line should be switched while the clock is LOW to avoid generating a STOP condition. (In other embodiments, other START and STOP conditions may be specified.)

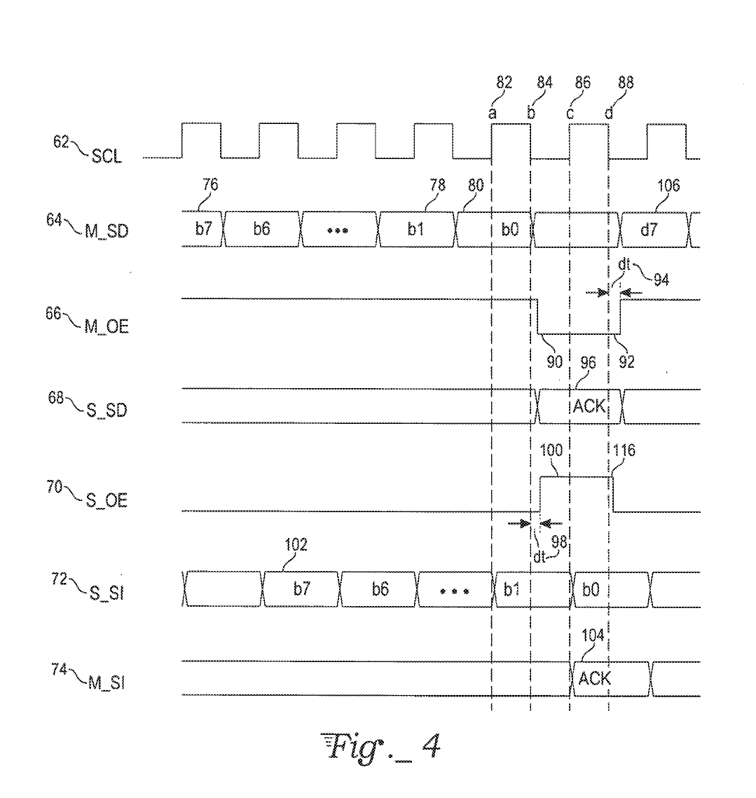

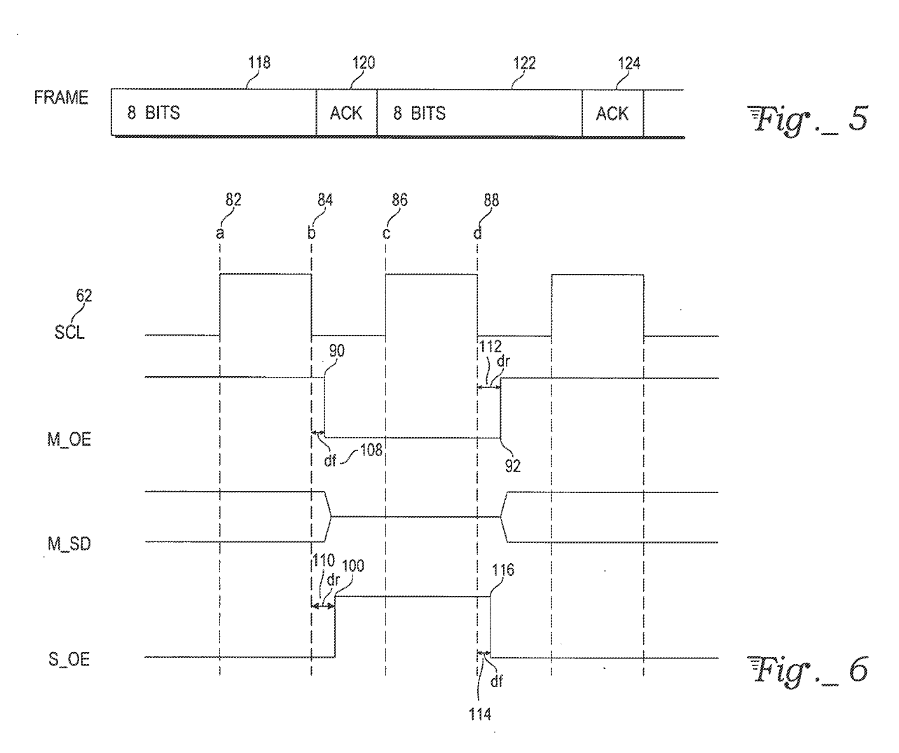

In FIG. 4, an exemplary timing diagram shows SCL 62, the master serial data (“M_SO”) signal 64, M OE 66, the slave serial data (“S_SD”) signal 68, S_OE 70, the slave serial data in (“S_SI”) signal 72, and the master serial data in (“M_SI”) signal 74. As shown in FIG. 5, the byte frame is 8 bits of data 118 sent, followed by a 1-bit acknowledge signal (“ACK”) 120, 8 bits of data sent 122, then an ACK 124, etc. There are thus 2 switches of control of the line per byte sent (i.e., control of the line is switched at the beginning of the ACK bit and at the end of the ACK bit). Returning to FIG. 4, M_SD 64 shows the master device is sending 8 bits of data, starting with bit 7 (“b7”) 76 and ending with bit 0 (“b0”) 80. Data are sent on the negative edge of SCL 62. M_OE 66 is HIGH while the data are sent; S_OE 70 is low while the master sends data. Data are sampled on the rising edge of SCL; as shown by S_SI 72, there is a half-phase delay for sampling data (S_SI 72 shows b7 102 is sampled a half phase after it was sent). As shown in FIG. 3, above, each device has an edge-triggered flip-flop 32, 34 which provides the sampling of the received data on the rising edge of SCL 62. Returning to FIG. 4, it can be seen on S_SD 68 that the ACK bit 96 is sent after b0 80 is sent, when S_OE 70 is HIGH and M_OE 66 is low. M_SI 74 indicates that the ACK bit 104 received by the master is sampled on the rising edge of SCL.

The delays to the output enable signals are added to the positive and negative edge of the output enable signals. The delay added to the positive edge of the enable signals, dt, 94, 98 is seen in FIG. 4 on both the M_OE 66 and S_OE 70 signals. Points a 82, b 84, c 86, and d 88, indicating the period during which control of the SD line is switched, are shown in greater detail in FIG. 6. In FIG. 6, at point a 82, SCL 62 is rising, M OE 66 is HIGH, M_SD 64 is sending data, and S_OE 70 is low. At point b 84, SCL 62 is falling, and the M_OE 66, M_SD 64, and S_OE 70 are as described at point a 82, above. However, shortly after point b 84, M_OE 66 goes low at point 90 and S_OE 70 goes HIGH at point 100. In other words, control of SD is switched. A delay, df 108, between the falling, or negative, edge of SCL 62, and the falling edge 90 of M_OE is shown; this delay may be controlled programmatically (as will be discussed below). A similar delay, df 114, is observed on the falling edge 116 of S_OE 70 at time d 88, when control of the line is switched again and S_OE 70 goes HIGH. A delay, dr 112, in the rise of M_OE 66 between time d 88 and the rising, or positive, edge 92 of M OE is indicated, as is a similar delay, dr 110, in the rise of S_OE 70 between time b 84 and the rising edge of S_OE 70. As with df, dr may be controlled programmatically and will be discussed below. The switch in control of the line (i.e., when M_OE 66 goes LOW 90 and S_OE 70 goes HIGH 100, when S_OE 70 goes LOW 116 and M_OE 66 goes HIGH 92) occurs when SCL 62 is LOW. The driver which has the line has to drive to the next positive clock edge so the listening device has the opportunity to send data and take control of the line when the clock is low.

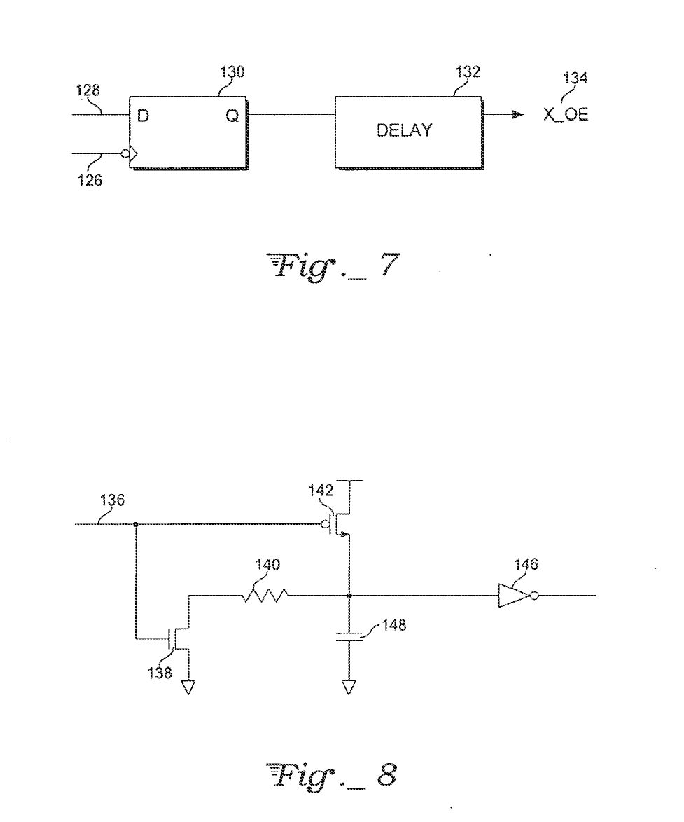

A delay circuit adds the delay to the edges of the enable signals. With reference to FIG. 7, in one embodiment the exemplary delay may be added when a bit counter (not shown) counts a number of bits and triggers a flip-flop 130, which in turn triggers a delay circuit 132 which adds the delay to either the master or slave enable signal (“X_OE”) 134. This circuitry is present on both the master and slave devices. For instance, at the master device, the bit counter would single out the ACK_SLOT signal, which is active during the ACK bit time slot. When the bit counter detects the ACK SLOT signal at the “D” input 128, the flip-flop is triggered on the negative edge of the clock signal of the flip-flop 130 enable input 126 and the delay circuit 132 is triggered. Both devices, in this case the flip-flops (both the flip-flops associated with generating the enable signal delay as well as the sampling delay) sample the clock signal from the SCL line.

In FIG. 8, another exemplary delay circuit in one embodiment features a p-type transistor 142, an n-type transistor 138, a resistor 140, a capacitor 148, and an inverter 146. When the input 136 to the circuit is LOW, there is no resistance and the p transistor 142 pulls up the capacitor 148 quickly. The fall time of the enable signal is fast. However, when the input is HIGH, the n transistor 138 cannot discharge the capacitor 148 quickly because of the resistor 140. This results in a delay in rise time dr that is greater than the delay in fall time df. The delay in fall time is less than the delay in rise time to ensure that the devices' drivers do not turn on at the same time. (The delay in rise time is the delay dt added to the positive edge of an enable signal.)

The flip-flops which add the delays to the enable signals each sample the clock signal from the SCL line. While the master device has access to the clock, the slave doesn't see the same clock (since the devices are on different silicon). Therefore, the flip-flops sample the clock from the pins on the devices. As noted above, in FIG. 3, there is some resistance 52, 54 on SCL line 12. Therefore, if both devices are sampling the clock signal from the SCL line, there is some clock skew or jitter between the signals sampled at both devices. The delay dt added to the output enable signal has to be greater than the clock jitter. The delay dt should also be greater than the deasserting time of the tri-state buffers.

In one example, in a 10 mm wire with a targeted speed of 10 MHz and a 100 nsec period, a delay dt of 20 nsec is added to the output enable signal (the delay in fall time, df, would be about 1 nsec). In the absence of the pull-up resistor on buses in the prior art, where the speed of the bus is limited by R_{pull up}*C_{load}, the primary limitation on the speed of the interface described in the above embodiments is delay dt. Other embodiments may feature different delays, which may be controlled programmatically to give greater flexibility to an application designer.

In other embodiments, multiple masters and slaves may be present. In an embodiment with multiple slaves and a single master, the master broadcasts an address to identify the slave device of interest. In other embodiments, a slave select line may be added.

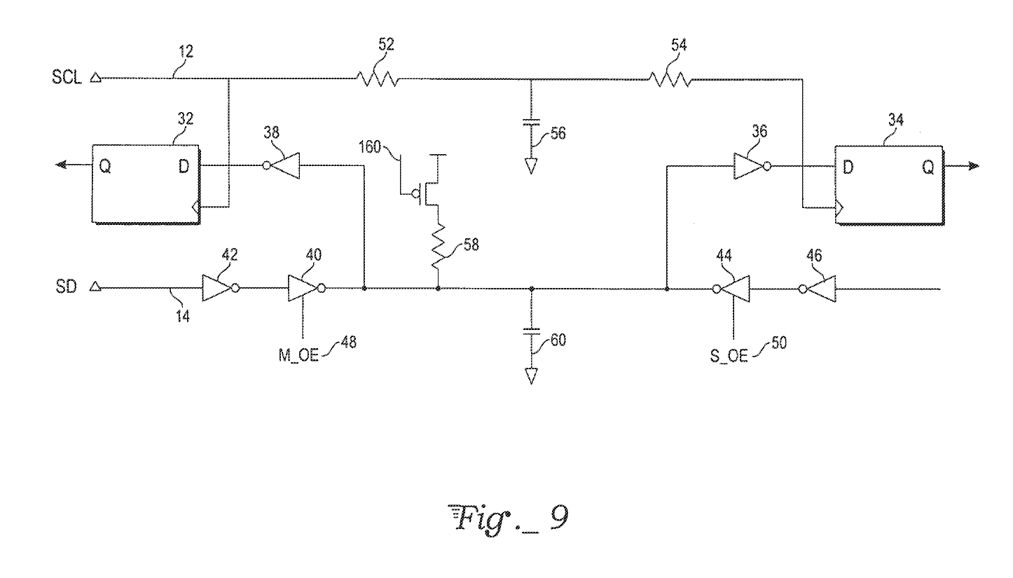

With reference to FIG. 9, an exemplary embodiment featuring multiple masters requires an arbitrator or supermaster 160 to avoid a collision between master devices trying to control the line at the same time. The first master device which successfully pulls down resistor 58 wins control of the line. Once the master is enabled, the super master 160 disables itself for the remainder of the session and the interface operates as described above.

Although the present invention has been described in terms of specific exemplary embodiments, one skilled in the art will recognize that variations and additions to the embodiments can be made without departing from the principles of the present invention.

What is claimed is:

1. An interface between at least two devices, the interface comprising:
a) a serial clock line coupled to each device;
b) a bidirectional serial data line coupled to each device; and
c) a first driver associated with a first of the two devices, the first driver including a first inverter, a first tri-state buffer, a second inverter and a first edge-triggered flip-flop, the first inverter and the first tri-state buffer connected in series in the bidirectional serial data line, an output of the tri-state buffer connected to an input of the second inverter, an output of the second inverter coupled to an input of the edge-triggered flip-flop, the edge-triggered flip-flop being clocked by a clock signal from the serial clock line, where the first driver is configured to drive data on the bidirectional serial data line when a first device enable signal coupled to the first tri-state buffer is asserted, the first device enable signal having a first delay relative to the clock signal from the serial clock line added to an edge of the first device enable signal, the delay to the first device enable signal added to avoid a collision when switching control of the bidirectional serial data line between the first device and a second of the at least two devices, the bidirectional serial data line not employing a pull-up resistor.
